(19) United States
(12) Patent Application Publication
(10) Pub. No.: US 2001/0039765 A1
(43) Pub. Date: Nov. 15, 2001

(54) Removable door and hinge

(76) Inventors: Peter Andonian, Bellevue, WA (US); Kristina B. Andonian, Bellevue, WA (US)

Correspondence Address: PATRICK M. DWYER PC, SUITE 114, 1818 WESTLAKE AVENUE N, SEATTLE, WA, 98109, US

(21) Appl. No.: 09/853,739

(22) Filed: May 10, 2001

Related U.S. Application Data
(60) Provisional application No. 60/203,446, filed on May 10, 2000.

(51) Int. Cl. E05C 21/02

(52) U.S. Cl. 49/465

(57) ABSTRACT

A removable door and hinge for a container. The hinge has at least one tang that has an eccentric cross section with a shortest dimension and a longest dimension. The tang, and preferably a pair of tangs, is operably connected to the door and rotatably engageable within an inner cross section of a bracket. The bracket is operably connected to the container and has an opening wide enough to receive the shortest dimension of the tang and too narrow to receive the longest dimension of the tang. The bracket inner cross section is dimensioned to allow rotation therein of the tang cross section through an arc of about 90 degrees.

The hinge is connected to an upper portion of the container, the tang is connected to an upper portion of the door, and the door is rotatable from a downward closed position to an upward open position. The tang cross section longest dimension is preferably oriented to be generally parallel to the door plane such that the bracket can only receive the tang when the door is in the open position, and the tang can not be removed from the bracket when the door is in the closed position.

### TECHNICAL FIELD

The invention relates to the field of manufactured containers; more particularly, it relates to the field of landscape and lawn care equipment and debris and grass clipping catchers therefor, and especially to a removable door and hinge therefor.

### BACKGROUND OF THE INVENTION

Containers that require an operator openable door are typically provided with a hinged door. This is particularly so in lawn maintenance, where a mower is advantageously attached to a grass and debris catcher and the catcher is to be emptied frequently as work progresses. In this particular area, grass catchers typically have hinged or slotted doors with a latch of some kind to secure the door releasably in a closed position. When the catcher is full, an operator removes the catcher, releases the latch and elevates one end of the catcher to dump the clippings and debris into a dumpster or onto a plastic tarp or sheet.

In the latter case, the door readily swings open under the influence of the weight of the door and the debris in the container, which forces the door open to permit the contents to be dumped onto the tarp. In the former case however, the door, as it tries to swing open, typically encounters the rim of the collection barrel or dumpster and does not open fully, forcing the operator to both lift and shake the relatively heavy catcher, or even to hold the door open with one hand while shaking the catcher with the other. Even then this is sometimes not fully successful.

One existing catcher has a removable, non-hinged, door to deal with this latter problem, but the means whereby the door is removable is relatively clumsy in operation, and prone to jamming with particles of debris after several uses so that the door does not readily go back into its socket for closure. Two generally triangular sockets are provided to receive the two bottom corners of a removable door that slides into those sockets, when they are not jammed with grass clippings. In addition the latches provided in this model are relatively flimsy. The only way to get this door open is to remove it.

What is needed is a container with an optionally removable door where the removal mechanism is simple to operate, yet robust and durable.

### DISCLOSURE OF THE INVENTION

The invention is a removable door and hinge for a container. It is inexpensive to manufacture, low in cost to maintain and nearly impossible to break or foul, but it is simple to operate. Optionally the hinged door may be left in place during dumping.

The hinge has at least one tang that has an eccentric cross section with a shortest dimension and a longest dimension. The tang, which serves as a kind of hinge pin, and is preferably implemented as a pair of tangs, is operably connected to the door and rotatably engageable within an inner cross section of a hinge bracket. The bracket, and preferably a pair of brackets, is operably connected to the container and has an opening, or gap, wide enough to receive the shortest dimension of the tang cross section and too narrow to receive the longest dimension of the tang cross section. The bracket inner cross section is dimensioned to allow rotation therein of the tang cross section through an arc of about 90 degrees, though the arc can be between about 30 degrees and about 180 degrees, in alternative embodiments. The preferred pair of bracket and tang assemblies are disposed preferably symmetrically at an end of the container to form the hinges for a door that covers the opening in the container.

The bracket opening is preferably generally door-facing, with the bracket opening preferably generally vertically centered in the bracket. The bracket inner cross section is preferably generally that of a circle, and the diameter of the circle is about the same dimension as the longest dimension of the tang cross section. This provides an optional and advantageous kind of ‘self-cleaning’ action in the bracket, as the rotary motion of the tang in the bracket tends to sweep all invasive debris out of the bracket. The tang cross section can have any eccentric shape such as, but not limited to, rectangle, diamond, lozenge, ovoid, ellipse, egg, pear, triangle, regular polygon and irregular polygon, and the like non-concentric shapes.

In a preferred embodiment, the hinge is connected to an upper portion of the container, the tang is connected to an upper portion of the door, and the door is rotatable from a downward closed position to an upward open position. The tang cross section longest dimension is preferably oriented to be generally parallel to the door plane such that the bracket can only receive the tang when the door is in the open position, and the tang can not be removed from the bracket when the door is in the closed position.

In a preferred embodiment there are, at an upper edge of a distal end of a conventional container (distal with respect to any machinery to be attached to a feeding end of the container) at least two hinges as discussed above, each formed of one bracket and one tang. The brackets may advantageously be substantially ‘C’ shaped, with their openings facing away from the machinery end of the container. On a lower edge of the distal end of the container is a substantially ‘U’ shaped bracket, or the like, through which a conventional closure pin may be engaged.

An otherwise conventional door for the container is provided, the two tangs both generally eccentric in cross-section, and preferably more or less rectangular or lozenge shaped in cross-section. The tangs may project outwardly beyond the boundaries of the conventionally shaped rectangular door, and be substantially within the plane of the door, to form the two hinge pins that are receivable into the openings of the two C brackets and then rotatable therein. Door tangs may also advantageously be formed to be substantially within the circumference of the door, and in some embodiments may also not be within the door plane.

The door preferably has dependent from an outer bottom edge a hasp, or the like, a central slot of which is engageable over the U bracket, so that when a pin is a light finger press fit into the U bracket across the face of the hasp, the pin is removably engaged and the door is secured from opening. The door may optionally be in a light ‘sprung’ engagement with the container when closed, so that the hasp and bracket, or the like structure, are closed against the tension of the lightly sprung door, or alternatively, some other spring tension mechanism, the details of either of which will readily occur to those skilled in the art.

In operation, when the door is to be removed, the hasp pin is slid out, the door is manually raised to approximately horizontal, or substantially parallel to the plane of the top of the container, or the like position, and then pulled out of engagement from the C brackets by virtue of the unobstructed passage of the relatively narrower portion of the rectangular cross-section of the tangs through the narrow C bracket openings. When the door is to be replaced, the above process is simply reversed. Door release may also be effected by raising the end of the container opposite the door, as in dumping the contents, and the door will preferably fall out. It will be appreciated that this open position of the door is at least in part defined by a preferred orientation of the door tangs in the C brackets, and that other orientations lie within the scope of the invention as well.

Optionally, the door may be left attached to the container and dumped in a conventional manner by first removing the hasp pin, and then tilting the container to allow the debris and the door weight to open the door and keep it open while debris falls out into the dumpster or onto the tarp.

### BRIEF DESCRIPTION OF THE DRAWINGS

FIG. 1 is a front elevation of a door and hinge tang aspect of the invention.

FIG. 2 is a sectional view of the hinge tang of FIG. 1 along lines 2-2, shown in variants a through h.

FIG. 3 is a sectional view of the door and hinge tang of FIG. 1 along lines 3-3.

FIG. 4 is a front elevation of an alternate door and hinge tang aspect of the invention.

FIG. 5 is a sectional view of the door and hinge tang of FIG. 4 along lines 5-5.

FIG. 6 is a front elevation of a container opening with hinge bracket aspect of the invention.

FIG. 7 is a sectional view of the U bracket of FIG. 6 along lines 7-7.

FIG. 8 is a partial schematic front elevation of an alternate tang aspect of the invention.

FIG. 9 is a partial schematic side elevation of the alternate tang aspect of FIG. 8.

FIG. 10 is a side elevation of two aspects of the hinge bracket of the invention.

FIG. 11 is a side elevation of two alternate aspects of the hinge bracket of the invention.

FIG. 12 is a side elevation of two alternate aspects of the hinge bracket and hinge tang of the invention.

FIG. 13 is a sectional view of aspects of variants of the hinge tang of the invention.

### BEST MODE OF CARRYING OUT THE INVENTION

Turning now to the drawings, the invention will be described in preferred embodiments by reference to the numerals of the drawing figures wherein like numbers indicate like parts.

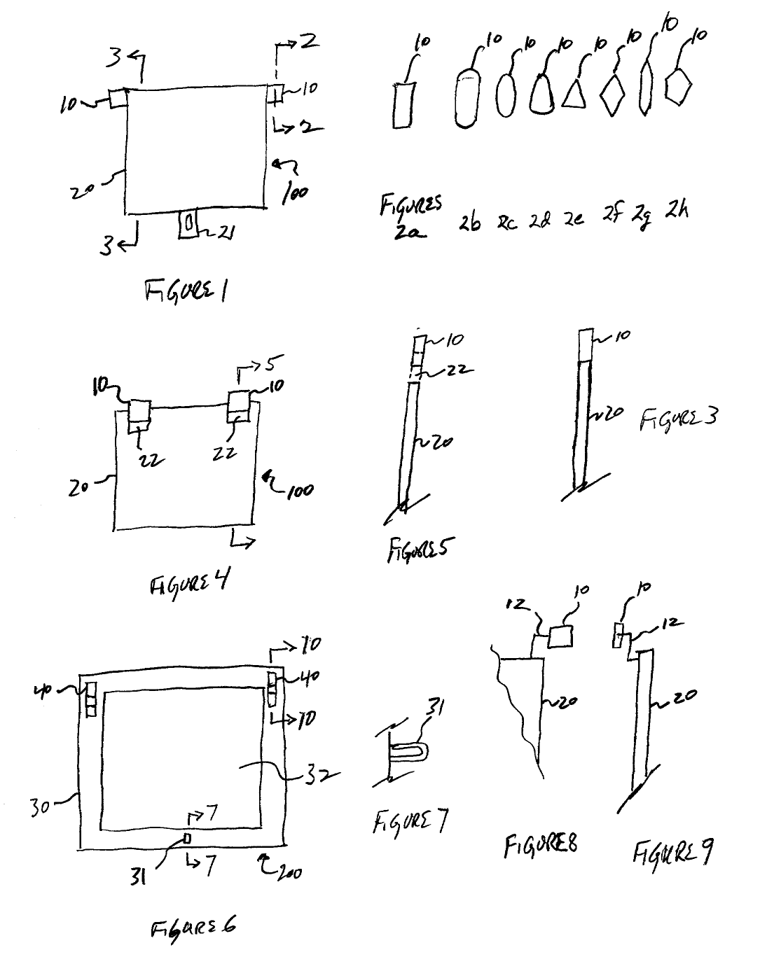

In FIG. 1 an otherwise conventional container door 20 is shown as part of door assembly 100. Door 20 has operatively attached thereto a conventional hasp 21, or the like latching structure. Each door 20 preferably has a pair of hinge tangs 10, generally symmetrically disposed upon door 20 for removable engagement with hinge brackets 40 (see FIG. 6). Tang positioning on door 20 will depend on whether the door is to be opened upward (hinged above), downward (hinged below), or sideways (side hinged); upward opening is preferred but not exclusively required. Directions indicated are with reference to the normal operational orientation of the container and door, as will be appreciated by those skilled in the art.

FIG. 2 shows a number of cross sectional variations for tang 10, as seen along line 2-2 in FIG. 1. A preferred rectangular cross sectional embodiment is shown in 2a (see also preferred relation of rectangle tang 10 to door 20 in FIG. 3), while 2b through 2h respectively show lozenge, ovoid or ellipse, pear, triangle, diamond, irregular polygon and regular polygon cross sectional shapes. These and other cross sectional shapes will serve in effecting the design of the invention in that they each have at least one longest dimension and one shortest dimension (also see FIG. 13 and further discussion below). It is believed that all the variants shown will be more or less efficacious in effecting the purposes of the invention.

In FIGS. 4 and 5 a variant door 20 and internal tangs 10 are illustrated. Tangs 10 are more or less integrated into periphery of door 20 in such a way as to leave openings 22 below each tang 10. This variant arrangement allows the door to be hinged, where deemed appropriate, without having the hinges be substantially outboard of door 20. That is, the hinges may thus be inboard of door 20. Openings 22 serve to receive the bottom cusp of bracket 40 (see FIGS. 6 and 10) after tang 10 is received into bracket 40 and door 20 is then allowed to close.

FIGS. 8 and 9 illustrate alternate dispositions of tangs 10 with respect to door 20 so that door 20 is not required to be more or less flush with brackets 40, such as when container designers desire to have a door offset from the opening end of a container and/or to have the door offset from the hinges. Tang connecting material 12 may be fashioned as will best be known to those skilled in the art for optimizing durability and appropriate rigidity of connection between door and tang.

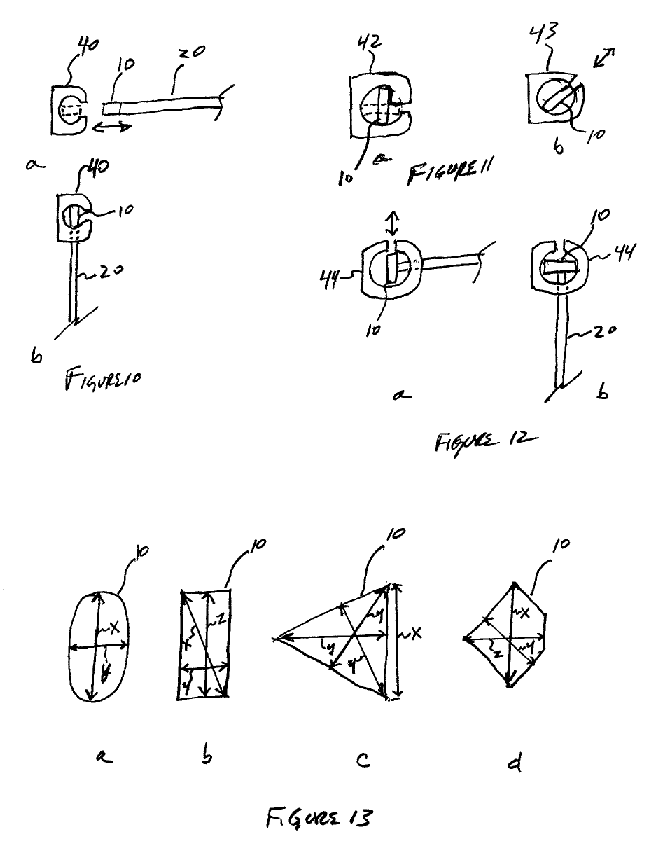

FIGS. 6 and 7 illustrate a conventional container opening 32 in container opening end 30, as part of container 200. U-bracket 31 is disposed to engage with hasp 21 shown in FIG. 1 to form a preferred door lock structure. Brackets 40 are generally symmetrically disposed to receive corresponding tangs 10 (see FIG. 1).

FIG. 10 (taken along line 10-10 of FIG. 6) illustrates a preferred “C” bracket (a) receiving and releasing tang 10 on door 20 into the interior of bracket 40 (motion shown by double headed arrow, received or inserted position of tang shown in broken line) while the door is in an upward or open position; and (b) rotatably holding tang 10 on door 20 within the interior of bracket 40 while the door is in a downward or closed position. Note also that tang 10 will be securely held within the interior of bracket 40 at nearly all rotational angles of the door (and tang) until they are at or very near the open position of the door, at which time the shortest dimension of tang 10 is presented to the gap in bracket 40 for optional release. In other words, the dimensions of the gap in bracket 40 and the shortest dimension of tang 10 are coordinated so that insertion and release of tang 10 in bracket 40 are only possible when it is the shortest dimension of tang 10 that is presented to the gap for movement therethrough. For tang cross sectional shapes like the rectangle, the shortest dimension and the longest dimension are offset by 90 degrees, so a fully closed position of the tang in the bracket is also offset from the open position by the same 90 degrees.

FIG. 11 shows two alternate aspects of bracket 40. Bracket 42 has a built in stop, shown for example in the upper right quadrant of bracket 42, though the stop could be in any quadrant depending on shape of tang and the desired open and closed stop positions. Multiple stops may be advantageously employed as well. As tang 10 moves from open or insert position (shown in broken line) to the vertical or closed position, it comes against the stop, urging the tang and its attached door to cease further movement in that direction. Bracket 43 illustrates a “G” bracket and has a higher positioned gap, to limit door tang insertion and removal (double arrow) to angles greater than 90 degrees from the closed position.

FIG. 12 illustrates yet further variants in bracket design and tang disposition with respect to door 20. Bracket 44 has an upward facing gap so tang 10 must be inserted and removed (double arrow) from above. So that door 20 may close in the full downward position, while tang 10 is in the closed position, the long dimension of tang 10 is offset with respect to door 20 by 90 degrees as compared to tang/door disposition illustrated in FIGS. 1 and 3, for instance. These geometries and the variants discussed above and below, as well as intermediary and other variants that will occur to those skilled in the art upon a reading and appreciation of the specification are all within the scope of the invention, and are provided to illustrate the breadth and depth of invention, wherein no one variant defines it exclusively.

FIG. 13 illustrates a comparison of various desirable cross sectional shapes, particularly with respect to the number and disposition of longest, shortest and intermediary cross sectional tang dimensions. For illustrative purposes only, various dimensions are scribed across the respective shapes and denominated with letters x for the longest dimension, y for the shortest dimension and z for intermediary dimension(s). In conjunction with a reading of the present specification, it will be appreciated by those skilled in the art that it is advantageous and therefore desirable to have a substantially shorter dimension for the shortest dimension y than the longest or intermediary dimensions x and z in each cross section. The gap in bracket 40 and its variants may thus be a minimal dimension for receiving and releasing tang 10, while serving to refuse passage to tang 10 when all other dimensions of the tang are presented at the gap. This allows for a maximum angular range of tang retention throughout the range of motion of the door/tang assembly 100. This is particularly the case with preferred cross sections a and b (rectangle and ellipse or ovoid, respectively). Ovoid cross section a has only two significant dimensions, within the scope of the invention, longest dimension x and shortest dimension y. Dimension x happens to be aligned with the long axis of the ovoid, while dimension y is aligned with the short axis of the ovoid. Rectangular cross section b however has three significant dimensions: longest dimension x, shortest dimension y and intermediary dimension z, where it is dimension z that is aligned with the long axis of the rectangle, while dimension x is aligned with the distance between opposite vertices (diagonal distance). It should be noted that for practical purposes, intermediary dimension z is treated as if it were the longest dimension in this specification for ease of aligning tang 10 with door 20 and coordinating bracket gap sizing and positioning while desirably having tang 10 in a vertical position when door 20 is fully closed; however, variations, including aligning rectangular tang 10 so that the true longest dimension x is vertical on door 20 closing will serve as well and are therefore included in the scope of the invention.

Regular polygon (isosceles triangle, for example) c also has only two significant dimensions: longest dimension x and shortest dimension y, by dimension y for regular polygons will have multiple instances. This tang cross section opens the possibility for allowing multiple exit points in the angular range of motion of door/tang assembly 100. For example, longest dimension x is presented once every 60 degrees (triangle sides are 120 degrees apart but the longest dimension is present twice in each 120 degrees, once near the gap and once farthest from the gap), and so are shortest dimensions y, where each y is offset from an x presentation by only 30 degrees. Thus an appropriately disposed triangular tang c in a bracket having a gap sized to dimension x may have dimension x presented at full door closing, thus retaining tang 10 in bracket 40 in this closed position, while a door raises of 30, 90 and 150 degrees from closed will all present dimensions y and thus allow removal of the door at positions in addition to the 90 degrees generally limited by other cross sectional variants described above. Other polygons will have different angular possibilities, as well as decreasing differences between dimensions x and y, to a practical limit that the polygon approaches the concentricity of a circular cross section and therefore not practical for use in embodiments of the invention.

Irregular polygon d presents further, and irregular, variations, having longest dimension x and shortest dimension y, but also having generally multiple possible intermediary dimensions z. Optionally, the gap in bracket 40 and the like may be sized to accept intermediary dimension(s) z, as well as dimension y. Those skilled in the art will now appreciate that angular offsets in door motion and tang release points may be tailored in both number and angular values by attention to the number and dimensions of the sides of the polygon, generally in accordance with the principles embodied in the discussion of regular polygons above.

Tang 10 and bracket 40 are preferably fashioned of solid metal conventionally compatible with the construction of the container. Aluminum of a grade that will be known to those skilled in the art is a preferred material for the container and the parts of the invention.

With regard to systems and components above referred to, but not otherwise specified or described in detail herein, the workings and specifications of such systems and components and the manner in which they may be made or assembled to effect the purposes herein disclosed, are all believed to be well within the knowledge of those skilled in the art. No concerted attempt to repeat here what is generally known to the artisan has therefore been made.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

We claim:

1. A removable door and hinge for a container, the hinge comprising a tang having an eccentric cross section with a shortest dimension and a longest dimension, the tang operably connected to the door and rotatably engageable within an inner cross section of a bracket, the bracket operably connected to the container and having an opening wide enough to receive the shortest dimension of the tang and too narrow to receive the longest dimension of the tang, the bracket inner cross section dimensioned to allow rotation therein of the tang cross section through an arc, the arc being between about 30 degrees and about 180 degrees.

2. The removable door and hinge of claim 1 wherein the arc is about 90 degrees.

3. The removable door and hinge of claim 1 wherein the bracket inner cross section is generally that of a circle.

4. The removable door and hinge of claim 3 wherein the diameter of the circle is about the same dimension as the longest dimension of the tang cross section.

5. The removable door and hinge of claim 1 wherein the tang cross section has a shape selected from the group of shapes consisting of rectangle, diamond, lozenge, ovoid, ellipse, egg, pear, triangle, regular polygon and irregular polygon.

6. The removable door and hinge of claim 1 wherein the bracket opening is generally door-facing.

7. The removable door and hinge of claim 6 wherein the bracket opening is generally vertically centered in the bracket.

8. The removable door and hinge of claim 1 wherein the hinge is connected to an upper portion of the container, the tang is connected to an upper portion of the door, and the door is rotatable from a downward closed position to an upward open position, the tang cross section longest dimension oriented to be generally parallel to a plane of the door such that the bracket can only receive the tang when the door is in the open position, and such that the tang can not be removed from the bracket when the door is in the closed position.
